(19) United States
(12) Patent Application Publication
(10) Pub. No.: US 2008/0109588 A1
(43) Pub. Date: May 8, 2008

(54) Memory Card and Method of Driving the Same

(76) Inventors: Eun-Jin Yun, Seoul (KR); Jin-Hyuk Kim, Seoul (KR); Dong-Gi Lee, Yongin-si (KR); Shea-Yun Lee, Seoul (KR)

Correspondence Address: F. CHAU & ASSOCIATES, LLC, 130 WOODBURY ROAD, WOODBURY, NY, 11797, US

(21) Appl. No.: 11/565,184

(22) Filed: Nov. 30, 2006

(30) Foreign Application Priority Data
Nov. 3, 2006 (KR) 10-2006-0108381

(51) Int. Cl. G06F 12/02

(52) U.S. Cl. 711/103; 711/115; 711/E12.008

(57) ABSTRACT

A memory card capable of having an increased number of meta blocks and a method of driving the memory card. A method of reading data from the memory card includes receiving logical addresses from a host. It is determined whether memory blocks corresponding to the received logical addresses belong to a first region allocated to a user data region in the memory card or a second region including meta blocks in the memory card. The memory blocks corresponding to the logical addresses are masked as erased blocks when the memory blocks belong to the second region.

### CROSS-REFERENCE TO RELATED PATENT APPLICATION

This application claims priority to Korean Patent Application No. 10-2006-0108381, filed on Nov. 3, 2006 in the Korean Intellectual Property Office, the disclosure of which is herein incorporated by reference.

### BACKGROUND OF THE INVENTION

1. Technical Field

The present disclosure relates to a memory card, and more particularly, to a memory card and a method of driving the memory card.

2. Discussion of the Related Art

Flash memory is an example of a nonvolatile memory capable of having data electrically stored and erased thereon. Flash memory consumed less power than a magnetic disk drive and has an access time at least as fast as a hard disk.

A memory card based on flash memory can have a large capacity and a high data transfer rate. An extreme digital picture card (hereinafter referred to as an xD card) is an example of a memory card based on flash memory. The xD card can be applied to a digital camera for the storage of digital images thereon. The xD card is considered to he a next-generation flash memory card using a NAND flash memory and is being developed to overcome limitations in the size and capacity of conventional smart media cards. xD cards may either use a small block NAND flash memory or a large block NAND flash memory. FIG. 1 illustrates a small block of a small block NAND flash memory applied to an xD card and a large block of a large block. NAND flash memory applied to an xD card.

Referring to FIG. 1, in the small block NAND flash memory, a single small block can include 32 pages each having 512 B. Thus, the size of a single small block of the small block NAND flash memory is 16 KB. In the large block NAND flash memory, a single large block can include 64 pages each having 2 KB. Thus, the size of a single large block of the large block NAND flash memory is 128 KB. Accordingly, a single large block of large block NAND flash memory has a capacity eight times that of a single small block of small block NAND flash memory.

The small block NAND flash memory and the large block NAND flash memory execute read/write requests differently. For small block NAND flash memory, each host request for a read/write operation is executed by a single read/write operation in the flash memory. However, in the large block NAND flash memory, each host request for a read/write operation may be executed by more than one read/write operation in the flash memory. For compatibility between an xD card including a large block flash memory and a host that requests the xD card to execute small-block-based operations, the xD card may include a built-in system such as a flash translation layer. The flash translation layer receives a small block address inputted to the xD card and calculates a block address corresponding to the small block address.

A plurality of memory blocks included in an xD card can be defined as a single zone. FIG. 2 illustrates two zones of an xD card, each zone includes a plurality of memory blocks. For example, a single zone can physically correspond to 1024 small blocks.

A predetermined number of memory blocks in each zone are used as meta blocks. The meta blocks store mapping information, log information and firmware information. An xD card manufacturer secures a predetermined number of meta blocks. In general, 16 blocks from 1024 small blocks of a single zone are used as meta blocks. A conventional approach to securing meta blocks in a specific region of a host is to mask the meta blocks as invalid blocks. For example, 1008 small blocks from the 1024 small blocks are secured as valid blocks and the remaining 16 small blocks are masked as invalid blocks. When a host requests an xD card to access a region masked as invalid blocks, the xD card informs the host that the region requested to be accessed corresponds to invalid blocks allowing the region to be used as meta blocks. This process is explained below with reference to FIG. 3.

FIG. 3 is a flow chart of a conventional process for accessing data between a host and an xD card. In the process illustrated in FIG. 3, the host provides a small block based address and the xD card includes a large block based NAND flash.

Referring to FIG. 3, a block access request is received from the host (Step S1). Then, the xD card judges whether memory blocks requested to be accessed are meta blocks using physical small block based addresses provided by the host (Step S2). If the xD card judges that the memory blocks requested to be accessed are meta blocks (Yes, Step S2) then the xD card informs the host that the blocks corresponding to the addresses are invalid blocks (Step S3). For example, in the case where 16 meta blocks are secured when the xD card is manufactured and the secured meta blocks are artificially masked as invalid blocks, when addresses corresponding to the meta blocks are input from the host, the xD card informs the host that the blocks corresponding to the addresses are invalid blocks.

When the memory blocks requested to be accessed are not invalid blocks (No, Step S23), the small block based addresses received from the host are mapped to large block based addresses of the xD card. Specifically, large block logical addresses are calculated from the physical small block addresses received from the host (Step S4), and then the large block logical addresses are mapped to physical addresses corresponding thereto (Step S5). Memory blocks corresponding to the physical addresses are then accessed (Step S6).

As described above, 1008 blocks per zone are secured as valid blocks and thus the remaining 16 blocks are masked as invalid blocks and used as meta blocks in an xD card. 1000 blocks of the 1008 blocks store user data information and the remaining 8 blocks are reserved blocks to be used as substitute blocks when a block genuinely becomes invalid, for example, due to corruption of the block or the like.

In this case, however, only the 16 masked blocks are used as meta blocks, and thus no more than 16 meta blocks may be secured. Furthermore, the number of blocks reserved for replacing genuinely invalid blocks is limited. In particular, in a multi-level cell based xD card, the amount of read/write/erase operations is twice that of a single-level cell based xD card, and thus the number of reserved blocks should be increased compared to the single-level cell based xD card. For example, a conventional xD card has a limited number of meta blocks and a limited number of reserved blocks preventing the number of meta blocks or reserved blocks from being increased.

### SUMMARY OF THE INVENTION

The present disclosure provides a memory card having an increased number of meta blocks or reserved blocks and a method of driving the same.

An exemplary embodiment of the present invention provides a method of reading data from a memory card. The method includes receiving logical addresses from a host. It is determined whether memory blocks corresponding to the received logical addresses belong to a first region allocated to a user data region the memory card or a second region including meta blocks in the memory card. When the memory blocks belong to the second region, the memory blocks corresponding to the logical addresses are masked as erased blocks.

The method of reading data may further comprise informing the host that the memory blocks requested by the host to be accessed are erased blocks.

The method of reading data may further comprise accessing the memory blocks corresponding to the received logical addresses when the memory blocks belong to the first region.

The logical addresses may be based on small blocks, and the memory blocks in the memory card may be large blocks.

The method of reading data may further comprise calculating are block based logical addresses from the small block based logical addresses when the memory blocks corresponding to the received logical addresses belong to the first regional. The large block based logical addresses are mapped to physical addresses. The memory blocks are accessed according to the mapping result.

The memory blocks in the memory card may include at least one zone comprising 1024 small blocks, the first region may correspond to 1000 small blocks per zone, and the second region may correspond to 24 small blocks per zone.

According to another exemplary embodiment of the present invention, a method of writing data to a memory card includes receiving user data and logical addresses from a host. It is determined whether memory blocks corresponding to the received logical addresses belong to a first region allocated to a user data region in the memory card or a second region including meta blocks in the memory card. When the memory blocks belong to the second region the memory blocks corresponding to the logical addresses are mapped to blocks belonging to the first region. The user data is written to the blocks of the first region according to the mapping result.

According to another exemplary embodiment of the present invention, a memory card includes a host interface receiving logical small block based addresses from an external host. A flash memory is based on large blocks. The flash memory includes a first region allocated to a user data region and a second region including meta blocks. A memory controller controls the flash memory in response to a control command from the host. In an operation of reading data from the memory card, when the memory blocks corresponding to the received logical addresses belong to the second region of the flash memory, the memory controller masks memory blocks corresponding to the received logical small block based addresses as erased blocks and informs the host of the information which indicates that the corresponding memory blocks are erased blocks.

### BRIEF DESCRIPTION OF THE DRAWINGS

The above and other features and aspects of the present disclosure will become more apparent by describing in detail several exemplary embodiments of the present invention with reference to the attached drawings in which:

FIG. 1 illustrates the structures of a small block NAND flash arid a large block NAND flash;

FIG. 2 illustrates zones defined as sets of plurality of memory blocks

FIG. 3 is a flow chart of a conventional process of accessing data between a host and an xD card;

FIG. 4 illustrates a method of driving a memory card according to an embodiment of the present invention

FIG. 5 illustrates memory blocks included in a memory card;

FIG. 6 is a flow chart of a reading operation of a memory card according to an embodiment of the present invention;

FIG. 7 is a flow chart of a write operation of a memory card according to an embodiment of the present invention;

FIG. 8 illustrates an example of using memory blocks according to an embodiment of the present invention; and

FIG. 9 is a block diagram of a memory card according to an embodiment of the present invention.

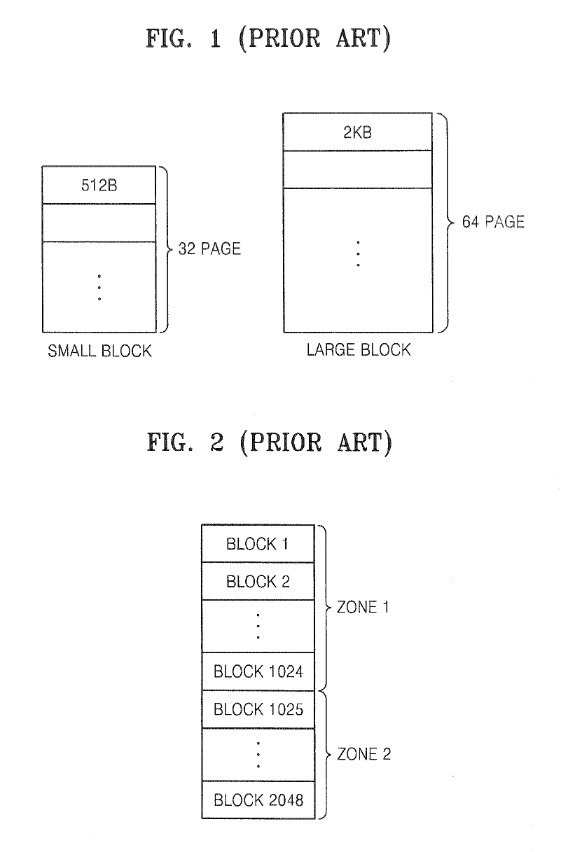

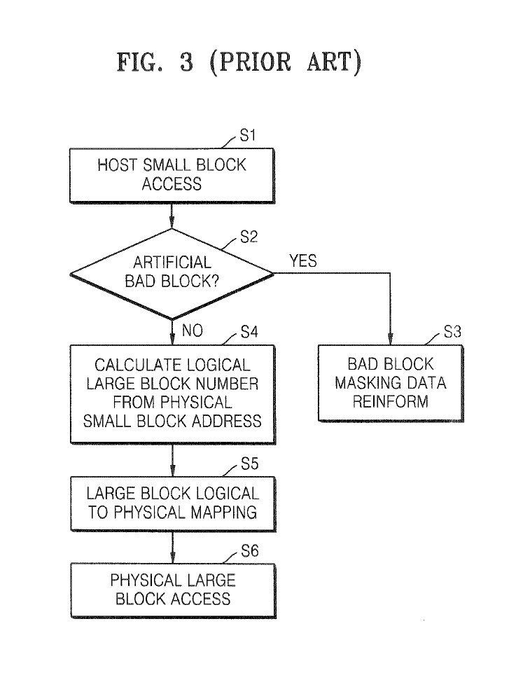

### DETAILED DESCRIPTION OF THE EXEMPLARY EMBODIMENTS

Exemplary embodiments of the present invention will now be described more fully with reference to the accompanying drawings. The disclosure may, however, be embodied in many different forms and should not be construed as being limited to the exemplary embodiments set forth herein; rather, these exemplary embodiments are provided so that this disclosure will be thorough and complete. Throughout the drawings, like reference numerals refer to like elements.

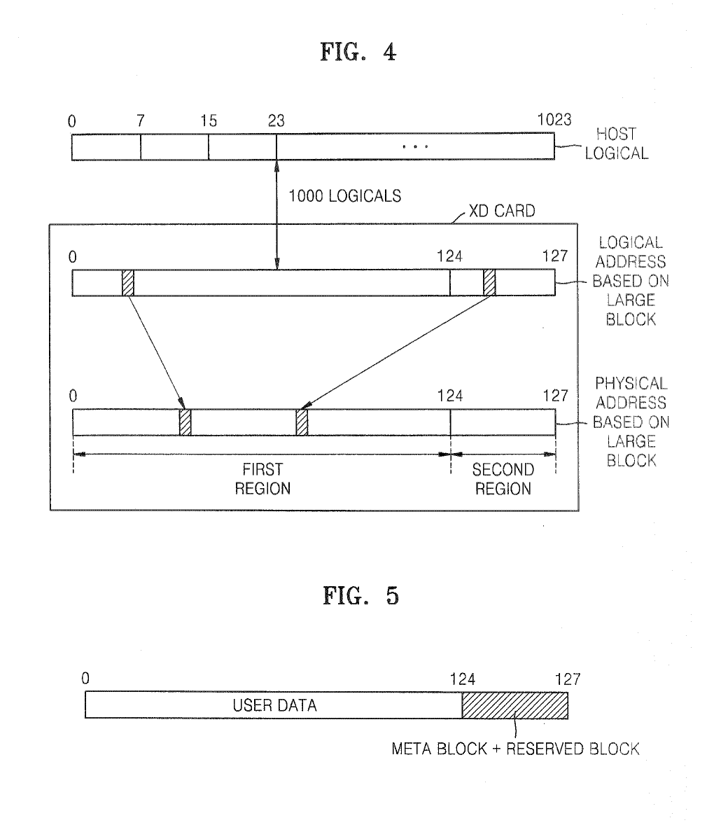

FIG. 4 illustrates a method of driving a memory card according to an exemplary embodiment of the present invention. Driving the memory card may include, for example, executing a read and/or write operation. Referring to FIG. 4, to perform a read/write operation on memory blocks, a host provides logical small block addresses to a memory card (for example, an xD card).

The host may request that the memory card secures at least 1008 memory blocks per zone as accessible blocks. The host logically uses 1000 blocks of the 1008 accessible blocks. Thus, the host provides 1000 logical addresses to the memory card in 0 order to perform the read/write operation on the memory blocks of the xD card.

The memory card receives the logical addresses from the host and performs the read/write operation on memory blocks corresponding to the logical addresses. As illustrated in FIG. 4, the memory card may include large block based memory blocks. For example, the memory card may include 128 memory blocks per zone. While FIG. 4 illustrates a mapping operation for a single zone, memory blocks corresponding to a plurality of zones can be included in the memory card.

The memory, card calculates large block based logical addresses using the small block based logical addresses received from the host. When the size of a single large block corresponds to 8 small blocks, for example, the memory card can calculate the large block based logical addresses using this information.

When the large block based logical addresses are calculated, physical addresses can be obtained using a predetermined mapping table (not shown). A predetermined read/write operation is performed on memory blocks corresponding to the physical addresses.

In a memory card according to an exemplary embodiment of the present invention, memory blocks included in the memory card are divided into a first region and a second region. The first region is a user data region storing user data information provided by the host and the second region includes meta blocks and reserved blocks. The meta blocks include mapping information, log information and firmware information and the reserved blocks are reserved to replace blocks which may become invalid.

When the small block based logical addresses are input from the host to perform a read/write operation on predetermined memory blocks, the memory card judges whether memory books corresponding to the small block based logical addresses belong to the first region or the second region. When the memory blocks corresponding to the small block based logical addresses belong to the first region, the memory card carries out the read/write operation on the memory blocks corresponding to the small block based logical addresses. For example, large block based logical addresses are calculated from the small block based logical addresses and mapped to physical addresses. Data stored in the memory blocks is output to the host in the case of a read operation and user data provided together with the small block based logical addresses is written to the memory blocks in the case of a write operation.

When the memory blocks corresponding to the small block based logical addresses received from the host belong to the second region the memory card performs the operation described below.

In a write operation the host provides user data and a small block based logical address and the memory card calculates a large block based logical address from the small block based logical address. Then, the memory card maps the calculated large block based logical address to one of blocks of the first region. Accordingly, the memory card writes the user data to the block of the first region and updates mapping information about this to a mapping table.

FIG. 4 illustrates a write operation of the memory card to write the user data provided by the host to the first region according to an exemplary embodiment of the present invention. The host provides 1000 logical addresses per zone with user data to the memory card. Accordingly, 1000 small blocks per zone in the memory blocks included in the memory card can be allocated to the first region and 24 small blocks can be allocated to the second region. The 1000 logical addresses are mapped to the first region of the memory blocks. When the memory blocks of the memory card are divided into a plurality of zones, the logical addresses can be mapped to the first region over a plurality of zones.

In a read operation when the memory blocks corresponding to the logical addresses received from the host belong to the second region, the memory card masks the corresponding memory blocks as erased blocks and transmits information about the masking of the memory blocks to the host. For example, when the host requests the memory card to access the second region, the memory card transmits information, which indicates that the corresponding memory blocks are erased blocks so that data can be written to the corresponding memory blocks, to the host. The memory card informs the host that the memory blocks of the second region are valid blocks, and thus the number of valid blocks requested by the host can be secured.

FIGS. 5 illustrates memory blocks included in a memory card according to an exemplary embodiment of the present invention. As illustrated in FIG. 5, large block based memory blocks can include 128 large blocks per zone.

When the host requests that the memory card write data, user data is dynamically mapped to the first region of the memory blocks in response to the logical addresses received from the host. For example, the first region can include 1000 small blocks (corresponding to 125 large blocks) and the second region can include 24 small blocks (corresponding to 3 large blocks). Since the host generally uses 1000 small block based logical addresses per zone, the 1000 small block based logical addresses are mapped to the blocks belonging to the first region of the memory card.

Accordingly, the second region can be used as meta blocks and reserved blocks. When the first region includes 1000 small blocks (corresponding to 125 large blocks), 24 small blocks (corresponding to 3 large blocks) can be used as meta blocks and reserved blocks. As a result, the number of meta blocks can be increased by 8, as compared to the conventional memory card, when it is desired that the number of meta blocks be increased, for example, when needed to improve the performance of the memory card.

Since the second region can be used as reserved blocks, an initial invalid block screening condition can be less strictly applied. For example, the number of block regions is increased and the number of meta blocks and the number of reserved blocks can be variable in the block regions, and thus the number of meta blocks and the number of reserved blocks can be increased when desired.

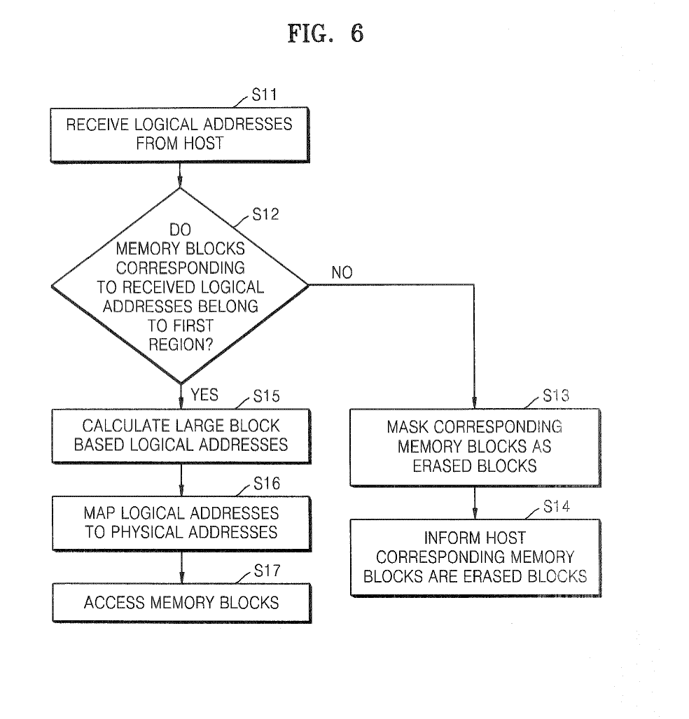

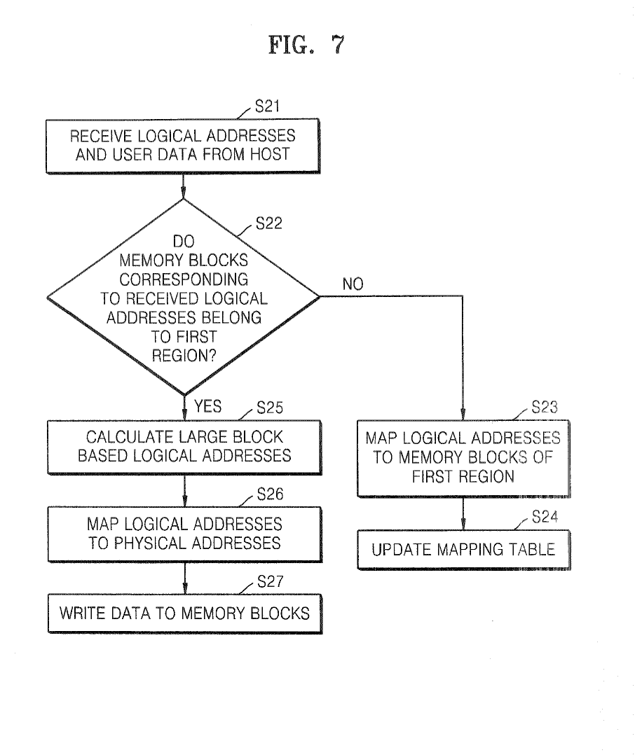

FIG. 6 is a low chart of a read operation of a memory card according to an exemplary embodiment of the present invention. FIG. 7 is a flow chart of a write operation of the memory card according to an exemplary embodiment of the present invention. Referring to FIG. 6, logical addresses are received from a host in operation (Step S11). As described above, the logical addresses provided by the host are based on small blocks.

The memory card determines whether the memory blocks corresponding to the received logical addresses belong to a first region allocated to a user data region or a second region including meta blocks (Step S12). When the memory blocks corresponding to the received logical addresses belong to the second region (No, Step S12), the memory card masks the corresponding memory blocks as erased blocks (Step S13) and informs the host that the corresponding memory blocks are erased blocks (Step S14).

When the memory blocks corresponding to the received logical addresses belong to the first region (Yes, S12), large block based logical addresses are calculated from the logical addresses received from the host (Step S15). Then, the calculated are block based logical addresses are mapped to physical addresses using a mapping table (Step S16); Subsequently, the memory blocks corresponding to the logical addresses received from the host are accessed (Step S17).

Referring to FIG. 7, logical addresses and user data are received from the host (Step S21). The memory card determines whether the memory blocks corresponding to the received logical addresses belong to a first region allocated to a user data region or a second region including meta blocks (Step S22). When the memory blocks corresponding to the received logical addresses belong to the second region (No, Step S22), the logical addresses are mapped to memory blocks of the first region (Step S23). Then, a mapping table is updated according to the mapping result (Step S24)

When the memory blocks corresponding to the received logical addresses belong to the first region (Yes, Step S22), large block based logical addresses are calculated from the logical addresses received from the host (Step S25). Then, the calculated large block based logical addresses are mapped to physical addresses using the mapping table (Step S26). Subsequently, the user data are written to the memory blocks corresponding to the physical addresses (Step S27).

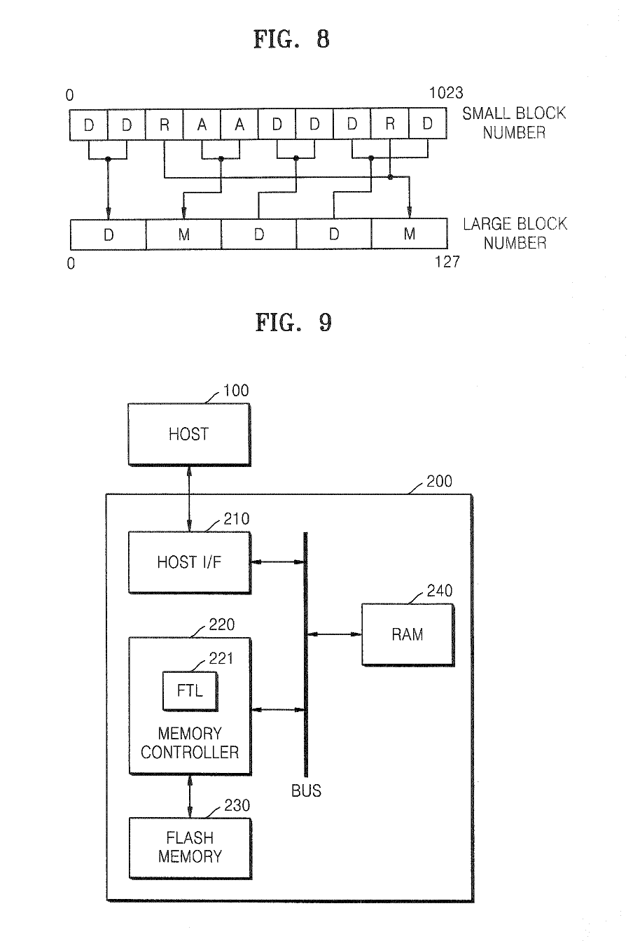

FIG. 8 illustrates an example of using memory blocks according to an exemplary embodiment of the present invention. As illustrated is FIG. 8, regions D having user data information are mapped to memory blocks in the memory card with reference to small block numbers of a host. Second region M of the memory blocks have a size corresponding to a conventional reserved region R and arbitrary invalid blocks A. As described above, 24 second regions M per zone can be secured so that the number of blocks used as meta blocks can be increased by 8 as compared to the conventional memory card.

FIG. 9 is a block diagram of a memory card 200 according to an exemplary embodiment of the present invention. Referring to FIG. 9, the memory card 200 is connected to a host 100 and receives small block based logical addresses and user data from the host 100.

The memory card 200 may include a host interface 210, a memory controller 220, a flash memory 230, and a RAM 240. The host interface 210 receives signals from the host 100 and transmits the received signals to predetermined components of the memory card 200 through a bus. The flash memory 230 includes a plurality of large block based memory blocks. The memory card 200 includes a plurality of zones each having 128 large blocks (corresponding to 1024 small blocks). In each zone, 125 large blocks (corresponding to 1000 small blocks) are defined as a fist region storing user data and 3 large blocks (corresponding 24 small blocks) are defined as a second region including meta blocks.

The memory controller 220 controls the flash memory 230 in response to a control command from the host 100. The memory controller 220 may include a flash translation layer 221. The flash translation layer 221 supports a block mapping technique for managing the flash memory 230.

The RAM 240 temporarily stores data when the memory card 200 is driven. The memory card 200 further includes a mapping table (not shown) storing information about mapping between logical addresses and physical addresses. The mapping table can be located in any position in the memory card 200. For example the mapping table can be located in the flash memory 230 or the RAM 240.

In a read operation the memory card 200 determines whether the memory blocks corresponding to logical addresses received from the host 100 belong to the first region or the second region. When the memory blocks belong to the second region the memory controller 220 masks the memory blocks corresponding to the logical addresses as erased blocks and provides the host 100 with the result of the masking representing that the memory blocks are erased memory blocks. Since the memory card 200 does not perform artificial invalid block masking, the host 100 recognizes that there are no invalid blocks in the memory blocks of the memory card 200.

In a write operation, the memory card 200 receives logical addresses and user data from the host 100. When the memory card 200 determines that the memory blocks corresponding to the logical addresses belong to the second region, the memory controller 220 maps the memory blocks corresponding to the logical addresses to blocks belonging to the first region. The user data is written to the blocks of the first region. The mapping table is updated according to the mapping result.

As described above, in the memory card and the method of driving the memory card according to exemplary embodiments of the present invention, the number of meta blocks and the number of reserved blocks can be increased as compared to a conventional memory card. Accordingly, the system performance of the memory card can be increased.

While exemplary embodiments of the present invention have been particularly shown and described with reference to the figures, it will be understood by those of ordinary skill in the art that various changes in form and details may be made therein without departing from the spirit and scope of the present disclosure.

What is claimed is:

1. A method of reading data from a memory card comprising:
receiving one or more logical addresses from a host;
determining whether one or more memory blocks corresponding to the received logical addresses belong to a first region allocated to a user data region in the memory card or a second region comprising meta blocks in the memory card; and
when the memory blocks belong to the second region, masking the memory blocks corresponding to the logical addresses as erased blocks.

2. The method of claim 1, further comprising informing the host that the memory blocks requested by the host to be accessed are erased blocks when the memory blocks belong to the second region.

3. The method of claim 1, further comprising accessing the memory blocks corresponding to the received logical addresses when the memory blocks belong to the first region.

4. The method of claim 1, wherein the logical addresses are based on small blocks and the memory blocks in the memory card are large blocks.

5. The method of claim 4, further comprising:
when the memory blocks corresponding to the received logical addresses belong to the first region, calculating large block based logical addresses from the received logical addresses;
mapping the large block based logical addresses to physical addresses; and
accessing the memory blocks according to the mapping result.

6. The method of claim 1, wherein the memory blocks in the memory card comprise at least one zone comprising 1024 small blocks, the first region corresponds to 1000 small blocks per zone and the second region corresponds to 24 small blocks per zone.

7. The method of claim 1, wherein the memory card is an extreme digital picture (xD) card.

8. A method of writing data to a memory card comprising:
receiving user data and one or more logical addresses from a host;
determining whether one or more memory blocks corresponding to the received logical addresses belong to a first region allocated to a user data region in the memory card or a second region comprising meta blocks in the memory card;
when it is determined that the memory blocks belong to the second region, mapping the memory blocks corresponding to the logical addresses to blocks belonging to the first region; and
writing the user data to the blocks of the first region according to the mapping result.

9. The method of claim 8, further comprising updating a mapping table storing information about mapping between logical addresses and physical addresses after the mapping of the memory blocks.

10. The method of claim 8, wherein the logical addresses are based on small blocks and the memory blocks in the memory card are large blocks.

11. The method of claim 10, wherein logical addresses corresponding to a group of memory blocks “n” allocated to the user data are mapped to physical addresses of the first region in the memory card.

12. The method of claim 11, wherein the memory blocks in the memory card include at least one zone comprising 1024 small blocks, and the size of the “n” blocks and the size of the first region correspond to 1000 small blocks per zone.

13. The method of claim 8, wherein the memory card is an xD card.

14. A memory card comprising:
a host interface receiving one or more small block based logical addresses from an external host;
a flash memory based on large blocks, the flash memory comprising a first region allocated to a user data region and a second region comprising meta blocks; and
a memory controller controlling the flash memory in response to a control command from the host,
wherein, in an operation of reading data from the memory card, when the memory blocks corresponding to the received logical addresses belong to the second region of the flash memory, the memory controller mask memory blocks corresponding to the received logical addresses as erased blocks and indicates to the host that the corresponding memory blocks are erased blocks.

15. The memory card of claim 14, wherein, in an operation of writing data to the memory card, when the memory blocks corresponding to the received logical small block based addresses belong to the second region of the flash memory, the memory controller maps the memory blocks corresponding to the received logical small block based addresses to blocks belonging to the first region and writes the user data according to the mapping result.

16. The memory card of claim 14, wherein the second region further includes reserved blocks, and when there is an invalid block in the memory blocks of the first region, the memory controller replaces the invalid block with one of the reserved blocks.

17. The memory card of claim 14, wherein the flash memory includes at least one zone comprising 1024 small blocks, the first region corresponds to 1000 small blocks per zone, and the second region corresponds to 24 small blocks per zone.

18. The memory card of claim 14, wherein the memory card is an xD card.
